(19) United States
(12) Patent Application Publication
(10) Pub. No.: US 2026/0203147 A1
(43) Pub. Date: Jul. 16, 2026

(54) API INTEGRATED MANAGEMENT SOLUTION PROVISION SYSTEM AND GATEWAY DEVICE USED THEREFOR

(71) Applicant: WEBARE SOFT INC, Seoul (KR)

(72) Inventors: Young Hwi JANG, Seoul (KR); Yong Hyuk KIM, Seongnamsi (KR); Yeon Ju LEE, Yongin-si (KR)

(73) Assignee: WEBARE SOFT INC, Seoul (KR)

(21) Appl. No.: 19/181,904

(22) Filed: Apr. 17, 2025

(30) Foreign Application Priority Data
Jan. 15, 2025 (KR) 10-2025-0005957
Jan. 15, 2025 (KR) 10-2025-0005958

(51) Int. Cl. G06F 9/54; G06F 3/04817; G06F 9/50

(52) U.S. Cl. CPC G06F 9/547; G06F 3/04817; G06F 9/5027

(57) ABSTRACT

A solution provision system including an administrator terminal that transmits information related to a first API for a specific service using an administrator account; a platform server that receives a registration request for a second API for a different service from the specific service from a developer terminal, registers the first API and the second API in an API product list, and provides the API product list to a client terminal using a user interface; and a gateway device that relays a communication connection between the client terminal and a plurality of API servers related to the first API and the second API.

### CROSS REFERENCE TO RELATED APPLICATION

The present application claims priority to Korean Patent Application Nos. 10-2025- 0005957 and 10-2025-0005958, filed on January 15, 2025, the entire content of which is incorporated herein for all purposes by reference.

### BACKGROUND

### Field

The present invention relates to an API integrated management solution provision system and a gateway device used therefor.

### Description of Related Art

Recently, in the software development and operation environment, various studies on application programming interfaces (APIs) are being conducted in response to the demand for integration between various services and systems. The APIs serve to relay between applications and systems so that the applications and the systems may interact with each other. To this end, the APIs are provided in a standardized manner so that the applications may exchange data with other software components or call functions included in other software.

In this regard, it is common for the APIs to be implemented according to individual services in the past, and a separate programming process may be required to call external services. Therefore, there is a need for a method capable of efficiently managing various APIs, stably providing these APIs to users, and packaging the APIs in various forms and providing the packaged APIs as subscription services.

### SUMMARY

The present invention relates to an API integrated management solution provision system capable of efficiently using various APIs, and a gateway device used therefor.

In addition, the present invention relates to an API integrated management solution provision system capable of packaging and subscribing services for APIs, and a gateway device used therefor.

Further, the present invention relates to an API integrated management solution provision system capable of allowing an API gateway to stably process a predetermined task requested from a client terminal, and a gateway device used therefor.

To solve the above-described problems, according to the present invention, a solution provision system includes: an administrator terminal that transmits information related to a first application programming interface (API) for a specific service using an administrator account; a platform server that receives a registration request for a second API for a different service from the specific service from a developer terminal, registers the first API and the second API in an API product list, and provides the API product list to a client terminal using a user interface; and a gateway device that relays a communication connection between the client terminal and a plurality of API servers related to the first API and the second API, in which the platform server may provide a subscription list indicating at least one of the first API and the second API for which a subscription is requested to the gateway device, based on the subscription request for at least one of the first API and the second API received from the client terminal, and the gateway device may construct the API gateway that integrates the at least one API based on the subscription list.

In addition, according to the present invention, a gateway device includes: a storage According to various embodiments of the present invention, the API integrated unit that stores information related to a plurality of APIs prepared in advance; and a control unit that constructs the API gateway that relays a communication connection between a client terminal and an API server based on at least one of the specified APIs, and generates a plurality of replication gateways that operate identically to the API gateway, in which the control unit may control the plurality of replication gateways based on a task requested from the client terminal for a plurality of functions provided by the API server, identify status information for each of the plurality of replication gateways, select any one of the plurality of replication gateways based on the identification result, and process the task requested from the client terminal using the any one selected replication gateway.

According to various embodiments of the present invention, the API integrated management solution provision system and the gateway device used therefor can easily use various APIs by subscribing to the APIs provided by the developers and administrators through the API platform. In particular, by separately processing the APIs provided by the developers and the APIs provided by the administrators and packaging the APIs from various sources, it is possible for the users to easily construct the list of subscription services.

In addition, according to various embodiments of the present invention, the API integrated management solution provision system and the gateway device used therefor construct the API gateway by performing the routing for at least one API subscribed through the API platform and provide the constructed API gateway, so it is possible to efficiently use the API.

In addition, according to various embodiments of the present invention, the API integrated management solution provision system and the gateway device used therefor construct the API gateway by performing the routing for at least one API selected by the client terminal and provide the constructed API gateway, so it is possible to efficiently use the API.

In addition, according to various embodiments of the present invention, the API integrated management solution provision system and the gateway device used therefor generates the plurality of replication gateways implemented identically and controls the task to be distributed to the plurality of replication gateways according to the status of the API gateway, so the API gateway can stably process the predetermined task requested from a client terminal.

### BRIEF DESCRIPTION OF THE DRAWINGS

FIG. 1 illustrates a solution provision system according to the present invention.

FIG. 2 is a flowchart illustrating a solution provision method according to the present invention.

FIG. 3 illustrates an embodiment of selecting an administrator mode and a developer mode.

FIG. 4 illustrates an embodiment of registering a developer account.

FIG. 5 illustrates an embodiment of registering an API in an API product list.

FIGS. 6 to 8 illustrate an embodiment of managing an API product list on an API platform.

FIG. 9 illustrates an embodiment of searching for an API on the API platform.

FIGS. 10 and 11 illustrate an embodiment of requesting an API subscription on an API platform.

FIG. 12 illustrates an embodiment of constructing the API gateway.

FIGS. 13 to 15 illustrate an embodiment of providing a log for the API gateway.

FIG. 16A and FIG. 16B illustrate the gateway device according to the present invention.

FIG. 17 is a flowchart illustrating the API gateway control method according to the present invention.

FIG. 18 illustrates an embodiment of generating a replication gateway.

FIGS. 19 to 21 are flowcharts illustrating an embodiment of a method of controlling a replication gateway.

### DETAILED DESCRIPTION

Hereinafter, embodiments disclosed in this specification will be described in detail with reference to the accompanying drawings, but the same or similar components will be denoted by the same reference numerals independent of the drawing numerals, and an overlapping description of the same or similar components will be omitted. The terms "module" and "unit" for components used in the following description are used only to easily make the disclosure. Therefore, these terms do not have meanings or roles that distinguish from each other in themselves. Further, in describing the embodiments disclosed in this specification, if it is determined that a detailed description of related known technologies may obscure the gist of the embodiments disclosed in this specification, the detailed description thereof is omitted. In addition, it is to be understood that the accompanying drawings are provided only for easy understanding of embodiments disclosed in this specification, and the technical idea disclosed in this specification is not limited by the accompanying drawings, but includes all the modifications, equivalents, and substitutions included in the spirit and the scope of the present invention.

The terms including ordinal numbers such as first and second may be used to describe various components, but these components are not limited by these terms. The terms are used to distinguish one component from another component.

It is to be understood that when one component is referred to as being "connected to" or "coupled to" another component, one component may be connected directly to or coupled directly to another component or be connected to or coupled to another component with the other component interposed therebetween. On the other hand, it is to be understood that when one component is referred to as being "connected directly to" or "coupled directly to" another component, it may be connected to or coupled to another component without the other component interposed therebetween.

Singular forms include plural forms unless the context clearly indicates otherwise.

It will be further understood that the terms "include" or "have" used in the present application specify the presence of features, numerals, steps, operations, components, parts mentioned in the present specification, or combinations thereof, but do not preclude the presence or addition of one or more other features, numerals, steps, operations, components, parts, or combinations thereof.

### Overall Contents of The Present Invention - Contents of 50 Cases

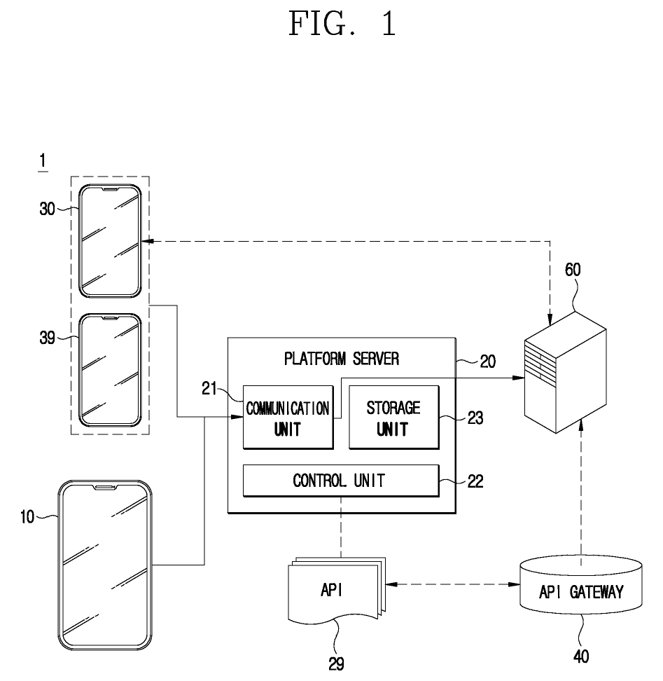

FIG. 1 illustrates a solution provision system according to the present invention.

Referring to FIG. 1, according to the present invention, a solution provision system 1 registers application programming interfaces (APIs)29 to which information related to the APIs 29 is transmitted in an API product list on a platform server 20 when the previously transmitted information related to the APIs 29 is transmitted from an administrator terminal 10 or a developer terminal 39 to the platform server 20, and provides a subscription list for at least one API 29 according to an API subscription request to a gateway device 60 when the subscription request for at least one API 29 according to the API product list is transmitted from a client terminal 30 to the platform server 20, so the gateway device 60 may construct the API gateway 40 corresponding to the subscription list.

Here, the subscription may mean an economic activity of continuously receiving services through a flat rate. In the present invention, the subscription service (or subscription- type service) may be provided by relaying a communication connection between the API server providing the API 29 for which the subscription is requested and the client terminal 30.

In this way, by subscribing to the API provided by the developer and the administrator, various APIs may be easily used on a client device.

Here, the API 29 may mean an interface that is implemented to call various functions provided by a specific service to perform a connection between software or a connection between hardware and software.

In this case, the service may mean a service provided through software, an application, an operating system, etc., and according to the embodiment, the service may be understood to mean the software, the application, or the operating system itself.

Therefore, the API 29 may be implemented to call a function provided by another software or application from specific software, application, or operating system. To this end, the API server may be implemented as a database for data used for the function provided through theAPI 29.

In this regard, the developer terminal 39 may include a user terminal that develops or distributes the specific API 29. To this end, the developer terminal 39 may be a user terminal registered on the API platform with a developer account. As another example, the developer terminal 39 may refer to a terminal that has logged in to the API platform with the developer account.

Here, providing the API 29 may be understood as the developer terminal 39 transmitting or uploading the information related to the API 29 to the platform server 20. In this case, the information related to the API 29 may include route information that can access a database (e.g., an API server) linked to the API 29, instructions for a function that can be processed through the API 29, authentication information for the API 29, version information for the API 29, etc.

To this end, the platform server 20 may receive a registration request for the developer account granted to the developer terminal 39 through an interface provided by the API platform to a client account, and grant authority corresponding to the developer account to login information for the corresponding client terminal 30 according to the registration request. For example, a user logs in to the API platform with the client account through the client terminal 30, and then request registration for the developer account.

Here, the login information is provided to distinguish different user accounts, and in one embodiment, the login information may include an ID (identify) and password pair, or a medium access control address (MAC) address granted to the developer terminal.

That is, the platform server 20 may be registered with the developer terminal 39 through the login information, and thus, the platform server 20 may register the API 29 received from the developer terminal 39 to which login information is granted in the API product list.

In this way, the platform server 20 may receive the API 29 from the developer terminal 39, register the received API 29 in the API product list, and provide the API product list through the interface provided by the API platform. In this case, the platform server 20 may receive different APIs 29 from the plurality of different developer terminals 39.

Accordingly, the API product list may include the plurality of different APIs 29, and each of the plurality of APIs 29 included in the API product list may be received from different developer terminals 39. The API product list may be implemented to be provided through an interface provided by the API platform to the client account.

That is, the API selected to be subscribed may be provided as the subscription service through the interface. In this case, the platform server 20 and the gateway device 60 may relay a communication connection between the API server providing the API selected to be subscribed and the client terminal 30, thereby providing the subscription service (or subscription-type service). In this way, by subscribing to the API provided by the developer and the administrator, various APIs may be easily used on the client device.

In this case, the API platform may be implemented as a website or an application so that the user terminals such as the developer terminal 39 and the client terminal 30 may access the API platform. Accordingly, the API platform may provide a previously implemented interface so that the developer terminal 39 may upload (or register) the API 29 to the API platform or the client terminal 30 may request an API subscription by specifying at least one API 29 from the API product list.

Meanwhile, an administrator account may be registered on the platform server 20. That is, the platform server 20 may grant the login information to the corresponding administrator terminal 10 based on the subscription request received from the administrator terminal 10 through the interface provided by the API platform. To this end, the login information may include information on the authority of the API platform to distinguish between the developer account, the administrator account, and the client account.

In this case, the administrator terminal 10 may perform management of the API 29 registered in the API product list (or, the platform server 20). Here, performing the management of the API 29 may include removing the API 29 registered in the API product list or performing verification of the API 29 received from the administrator terminal 10 or the developer terminal 39, and according to an embodiment, may include registering the API 29 uploaded to the platform server 20 from the administrator terminal 10 or the developer terminal 39 in the API product list. In addition, the administrator terminal 10 may provide the API 29 to the platform server 20 like the developer terminal 39.

In addition, the administrator terminal 10 may perform management of the API subscription for the API product list (or, platform server 20). Here, performing the management of the API subscription may include approving or rejecting the API subscription request received from the client terminal 30.

Meanwhile, the client terminal 30 is a user terminal registered on the API platform with the client account, and may request the API subscription for at least one API 29 from the API product list through the interface provided by the API platform. In this case, the API subscription may be selecting (or purchasing) at least one API 29 based on the interface provided by the API platform in order to use the API gateway 40 in which at least one API 29 is integrated.

To this end, the platform server 20 may grant the login information to the corresponding client terminal 30 based on the subscription request received from the client terminal 30 through the interface provided by the API platform. Here, the login information is provided so as to be able to distinguish different client terminals 30, and in one embodiment, the login information may include the ID and password pair, or the MAC address granted to the client terminal 30.

That is, the platform server 20 may be registered with the client terminal 30 through the login information, and thus, the platform server 20 may generate the subscription list based on the API subscription request received from the client terminal 30 to which the login information is granted and transmit the generated subscription list to the gateway device 60.

In addition, the client terminal 30 may utilize the API gateway 40 built in the gateway device 60 according to the API subscription request. That is, the client terminal 30 may access the API gateway 40 through the gateway device 60, and may utilize the service provided by at least one API 29 included in the API gateway 40.

In this regard, the gateway device 60 may receive a subscription list generated from the platform server 20 in response to the API subscription request from the client terminal 30, and may construct the API gateway 40 that integrates at least one API 29 based on the received subscription list.

Here, the API gateway 40 may be implemented to integrate and manage at least one API 29, and thus, when tasks for functions provided by at least one integrated API 29, respectively, are requested, the API gateway 40 may be implemented to call the API 29 corresponding to the received task and process the task previously received.

To this end, the gateway device 60 may perform routing on at least one API 29 integrated into the API gateway 40 in the process of constructing the API gateway 40. That is, the gateway device 60 may grant an access authority to access at least one API 29 through the API gateway 40 from the client terminal 30, and may set a route for functions provided by each of the at least one API 29.

For example, the gateway device 60 may generate authentication information so as to allow the access authority of the client terminal 30 to the API gateway 40, and generate individual authentication information to allow the access authority to at least one API 29 included in the API gateway 40 in response to the generated authentication information.

In addition, the gateway device 60 may generate identification information (e.g., ID), address information (e.g., uniform resource locator (URL)), etc., corresponding to a functional access route of at least one API 29 included in the API gateway 40, and perform routing on the functions provided by at least one API 29.

In this regard, the gateway device 60 may receive a subscription list including information related to at least one API from the platform server 20, and may construct the API gateway based on the received information to relay the communication connection between the client terminal 30 and the plurality of API servers.

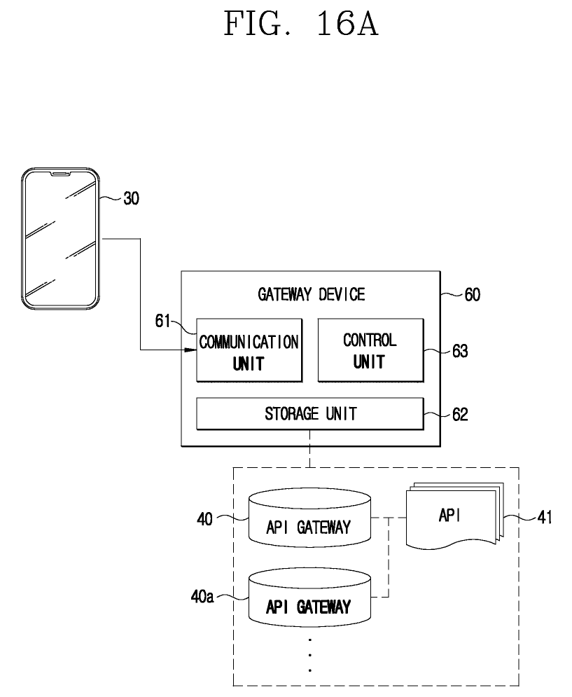

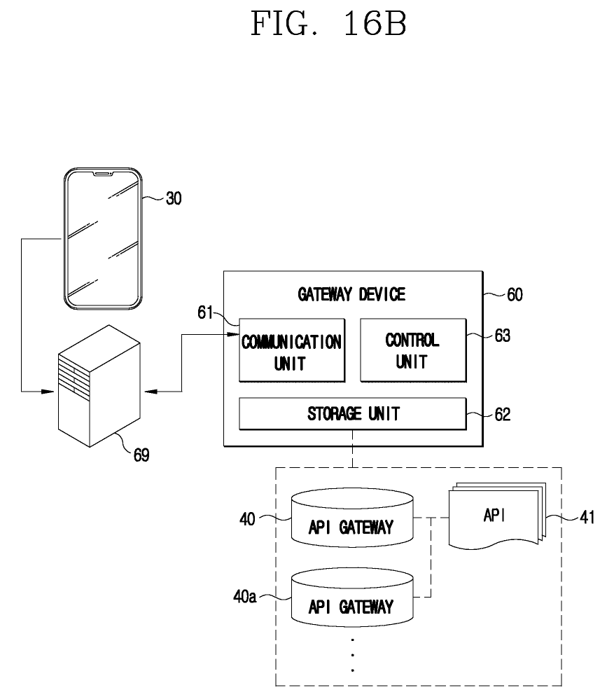

To this end, the gateway device 60 may be implemented as a server independent of the platform server 20 (see FIG. 16A below), etc. In this case, the gateway device 60 may include a communication unit 61, a storage unit 62, and a control unit 63.

The communication unit 61 may perform communication with the client terminal 30 and the API server, and may perform communication with a separate API manager device 69 (see FIG. 16B below). Here, the API manager device 69 may determine whether there is a gateway device 60 that has requested a routing policy, and may perform a function of transmitting the routing policy to the corresponding gateway device 60.

For example, the API manager device 69 may control whether to allocate a task to the API gateway 40 (or each of the plurality of replication gateways 40a) based on the task quantity requested from the client terminal 30. In this case, the API manager device 69 may allocate a task requested for the at least one API 41 to the API gateway 40 (or one of the plurality of replication gateways 40a) based on a task allocation algorithm prepared in advance.

More specifically, the API manager device 69 may compare the task quantity requested per predetermined time unit from the client terminal 30 with a predetermined reference value, and control whether to allocate a task to the API gateway 40 (or each of the plurality of replication gateways 40a) based on the comparison result.

However, the present invention is not necessarily limited thereto, and the API manager device 69 can also be operated in integration with the control unit 63 as illustrated in FIG. 16A. Hereinafter, for the convenience of description, the API manager device 69 and the control unit 63 are described as being integrated and operated.

The control unit 63 performs the overall control of the gateway device 60 and may be composed of a plurality of processors. The storage unit 62 may store data or software related to the API gateway 40 in which the API 29 is integrated, and may include memory, etc.

However, the present invention is not necessarily limited thereto, and according to an embodiment, the gateway device 60 may be implemented to be integrated and operated with the platform server 20. In this way, when operated in the integrated manner, the communication unit 21, the storage unit 22, and the control unit 23 of the platform server 20 can be integrated with the communication unit 61, the storage unit 62, and the control unit 63 of the gateway device (60), respectively.

Therefore, referring back to FIG. 1, using the API gateway 40 by the client terminal 30 may be using the API gateway 40 built through the gateway device 60. Therefore, the client terminal 30 may request the task for the predetermined API 29 from the gateway device 60 and receive the result of the requested task from the gateway device 60.

That is, the client terminal 30 may access a service provided by at least one API 29 included in the API gateway 40 based on at least one of the identification information and the address information for the predetermined API gateway 40.

In this case, when the gateway device 60 receives at least one of the identification information and the address information from the client terminal 30, the gateway device 60 may perform the authentication of the client terminal 30 on the API gateway 40 to identify the access authority for the client terminal 30 to the API gateway 40, and provide the API 29 corresponding to at least one of the identification information and the address information to the client terminal 30 based on the identification result.

In this regard, the platform server 20 may generate status information for the API gateway 40 and/or the API 29 provided through the API gateway 40 based on the log generated from the gateway device 60, and provide status information for the API 29 through the interface provided by the API platform.

Here, the status information may include information on a traffic usage (or limit) allowed for the API 29. In addition, the status information may include information such as the number of times the task is requested from the client terminal 30, the response time of the API 29 according to the task request from the client terminal 30, and the number of times errors have occurred (or error rate).

Meanwhile, when the platform server 20 receives the API 29 from the developer terminal 39 (or the administrator terminal), the platform server 20 may specify the information on the traffic usage (or limit) of the corresponding API 29. In this case, the platform server 20 may specify a predetermined traffic usage (or limit) for the API 29 received from the developer terminal 39 (or the administrator terminal), or may specify different traffic usage (or limit) for each predetermined group.

In addition, the gateway device 60 records a log such as an API task request of the client terminal 30 recognized by the API gateway 40 and a response to at least one API 29 included in the API gateway 40, and the platform server 20 may generate the status information for the API 29 or the API gateway 40 based on the log.

Meanwhile, the developer terminal 39, the administrator terminal, and the client terminal 30 may each be terms that are distinguished according to the form in which the user terminal is registered on the platform server 20. That is, the developer terminal 39 may indicate a user terminal whose login information is registered on the platform server 20 with the developer account, the administrator terminal 10 may indicate a user terminal whose login information is registered on the platform server 20 with the administrator account, and the client terminal 30 may indicate a user terminal whose login information is registered on the platform server 20 with the client account.

In this case, the user terminal may include devices such as tablets, personal computers, smartphones, and wearable devices. Therefore, the user terminal may log in to the API platform through the interface provided by the API platform, and may be logged in with any one of the developer account, the administrator account, and the client account based on the form in which the login information input during the login process is registered on the platform server 20.

In this regard, the administrator terminal 10 may also perform management of the login information registered on the platform server 20. That is, when the administrator terminal 10 receives a request for registration of the login information for the platform server 20 from the user terminal (e.g., the developer terminal 39, the client terminal 30, or the administrator terminal 10), the administrator terminal 10 may approve the requested login information and register the approved login information for the platform server 20 with any one of the developer account, the client account, and the administrator account, or reject the requested login information.

In addition, the administrator terminal 10 may inquire the login information registered on the platform server 20 and inquire an activity history (e.g., API registration, API subscription, etc.) of the user terminal corresponding to the specific login information.

Meanwhile, the solution provision system 1 according to the present invention may include the administrator terminal 10, the platform server 20, and the gateway device 60. In this case, the platform server 20 may include the communication unit 21, the storage unit 22, and the control unit 23. The communication unit 21, the storage unit 22, and the control unit 23 may be connected to each other through a system bus, a network, or other connection mechanisms.

The communication unit 21 may be connected to the developer terminal 39, the administrator terminal 10, and the client terminal 30 through a wireless or wired network. Accordingly, the communication unit 21 may receive the API 29 from the developer terminal 39 or the administrator terminal, and the communication unit 21 may receive the API subscription request for at least one API 29 from the client terminal 30.

In addition, the communication unit 21 may also receive a predetermined keyword or word for searching for the API 29 registered in the API product list from the client terminal 30.

In addition, the communication unit 21 may approve the registration of the login information from the administrator terminal 10 or receive a request to approve registration of the API 29 received from the developer terminal 39, and the communication unit 21 may receive from the administrator terminal 10 a request to approve the API subscription request from the client terminal 30.

The communication unit 21 may include one or more device that provide one or more wireless interface(s) and/or one or more wired interface(s) that can be configured to communicate through a network. In addition, the communication unit 21 may be configured to provide reliable security and/or authenticated communication.

In addition, the storage unit 22 may store instructions and information necessary for the operation of the platform server 20. For example, the storage unit 22 may store the API 29 received from the developer terminal 39 and the administrator terminal 10, and store the API product list. In addition, the storage unit 22 may store information (e.g., the API route and function, etc.) related to the subscription list generated in response to the API subscription request from the client terminal 30.

In addition, the storage unit 22 may store a log recorded in the gateway device 60, and store the status information, the statistical information, etc., that are generated based on the log. In addition, the storage unit 22 may store the login information registered by each of the developer terminal 39, the administrator terminal 10, and the client terminal 30.

The storage unit 22 is data storage, and may include one or more non-transitory computer-readable storage media that may be read and/or accessed by the control unit 23 (for example, at least one of the one or more processors).

One or more non-transitory computer-readable storage media may include volatile and/or non-volatile storage components such as optical, magnetic, organic or other memory or disk storage devices. In some examples, the storage unit 22 may be implemented using a single physical device (e.g., one of optical, magnetic, organic, or other memory or disk storage device), while in other examples, the storage unit 22 may be implemented using two or more physical devices.

In addition, the storage unit 22 may include computer-readable instructions and additional data. The storage unit 22 may include storage necessary to perform at least some of methods, scenarios and techniques described herein and/or at least some of the functions of the devices and networks.

The control unit 23 may control the overall operation of the platform server 20. That is, the control unit 23 may register the APIs 29 to which information related to the APIs 29 is transmitted in the API product list on the platform server 20 when the previously transmitted information related to the APIs 29 is transmitted from the administrator terminal 10 or the developer terminal 39 to the platform server 20, and provide the subscription list for at least one API 29 according to the API subscription request to the gateway device 60 when the subscription request for at least one API 29 according to the API product list is transmitted from the client terminal 30 to the platform server 20, so the gateway device 60 may construct the API gateway 40 corresponding to the subscription list.

Specifically, the control unit 23 may receive information related to a first API for a specific service from the administrator terminal 10.

To this end, the control unit 23 may output an icon prepared in advance to select the terminal 10 selects the developer mode through the user interface. developer mode and the administrator mode to the user interface provided to the administrator account through the API platform. Accordingly, the administrator terminal 10 may output a screen that can use the authority, the function, etc., that are granted by the API platform to the administrator account, when the administrator terminal 10 selects the administrator mode through the user interface, and may also output a screen that can use the authority, the function, etc., that are granted by the API platform to the developer account, when the administrator terminal 10 selects the developer mode through the user interface.

Meanwhile, the control unit 23 may register the first API in the API product list, register the second API in the API product list when receiving a registration request for a second API for a different service from the specific service from the developer terminal 39, and provide the API product list to the client terminal 30 using the user interface.

That is, the control unit 23 may upload the information related to the API (e.g., the second API) implemented to provide a predetermined service to the platform server through the user interface of the API platform provided by the developer account.

Meanwhile, when the control unit 23 receives the information related to the API 29 from the administrator terminal 10 or the developer terminal 39, the control unit 23 may request approval for the corresponding API 29 from the administrator account. In this way, the control unit 23 may register information related to the approved API 14 in the API product list, and provide a list of approved APIs 14 to the client account through the API platform 53.

Furthermore, the control unit 23 may provide the subscription list indicating at least one API 29 for which the subscription is requested to the gateway device 60 based on the subscription request for at least one of the first API and the second API received from the client terminal 30.

To this end, the control unit 23 may receive search information from the client terminal 30 through the user interface provided by the API platform to the client account, and specify the API 29 corresponding to the received search information.

In addition, when a sorting mode for the API product list is selected through the user interface provided by the API platform to the client account, the control unit 23 may specify at least one of the plurality of APIs 29 registered in the API product list based on a predetermined priority according to the selected sorting mode, and provide the information related to the specified API 29 to the client terminal 30.

Therefore, when the subscription request for at least one API 29 is received based on the API product list, the control unit 23 may provide the information related to at least one API 29 for which the subscription is requested and the information related to the corresponding client account through the user interface provided to the administrator account, thereby specifying whether to approve the subscription for the corresponding subscription request.

Furthermore, when the subscription request for at least one API 29 is approved from the administrator terminal 10, the control unit 23 may generate the subscription list based on the information related to at least one API 29 according to the subscription request and transmit the subscription list to the gateway device 60.

In this regard, the gateway device 60 may perform the routing on at least one API 29 for which the subscription is requested based on the subscription list received through the communication unit 21 of the platform server, thereby constructing the API gateway 40 that integrates at least one API 29.

Meanwhile, the control unit 23 may receive a log from the gateway device and generate the status information and the statistical information for at least one API 29 included in the API gateway 40 based on the log.

Accordingly, the control unit 23 may provide the status information and the statistical information for at least one API 29 included in the API gateway 40 through the API platform, generate an API status report related to the API gateway 40, the status information and the statistical information based on a user input from the client terminal 30, and provide the previously generated API status report to the client terminal 30 through the API platform.

The control unit 23 is one or more processors, and may include one or more processors, and the processors may include one or more general-purpose processors and/or one or more special-purpose processors (e.g., a digital signal processor, a tensor processing unit (TPU), a graphics processing unit (GPU), a neural network processing unit (NPU), an application-specific integrated circuit, an application-specific integrated circuit (ASIC), etc.). The control unit 23 may be configured to execute the computer-readable instructions included in the storage unit 22 and/or other commands described herein.

Meanwhile, the solution provision system 1 may be a computing device including one or more sensors and/or a power system. Here, one or more sensors may be configured to measure conditions within the computing device and/or conditions of the computing device environment and provide data about these conditions. The power system may include one or more batteries and/or one or more external power interfaces for providing power to the computing device.

The solution provision method will be described in more detail below based on the configuration of the solution provision system 1 described above.

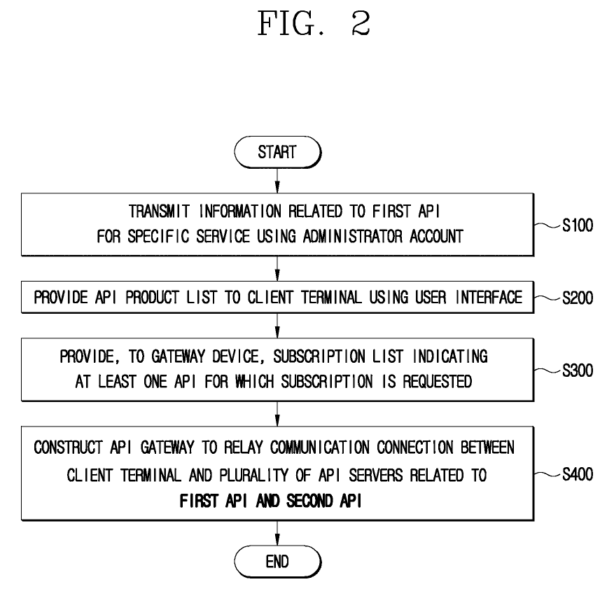

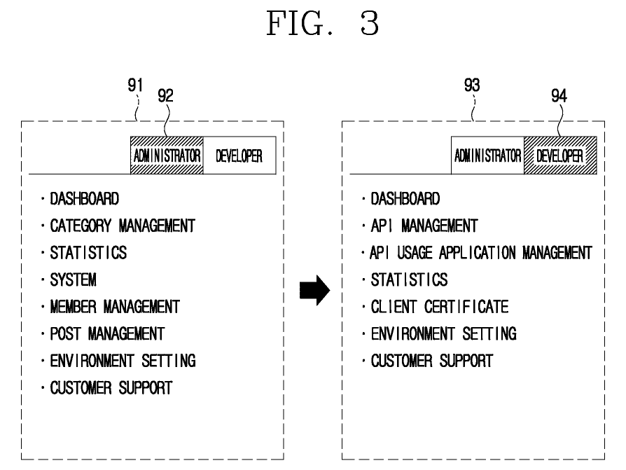

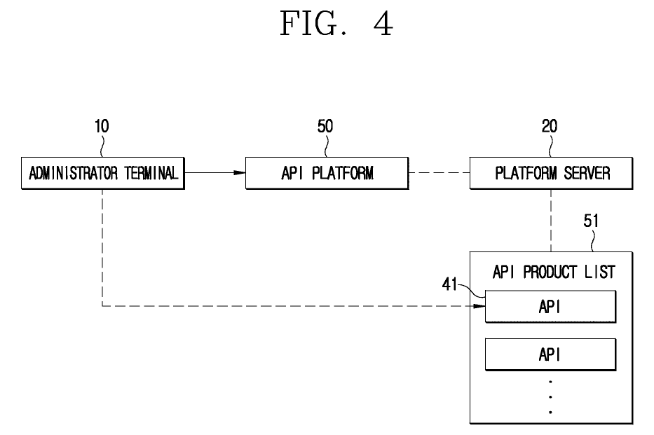

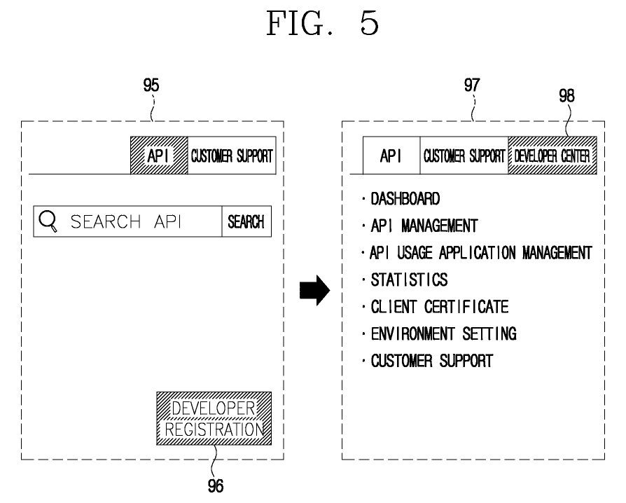

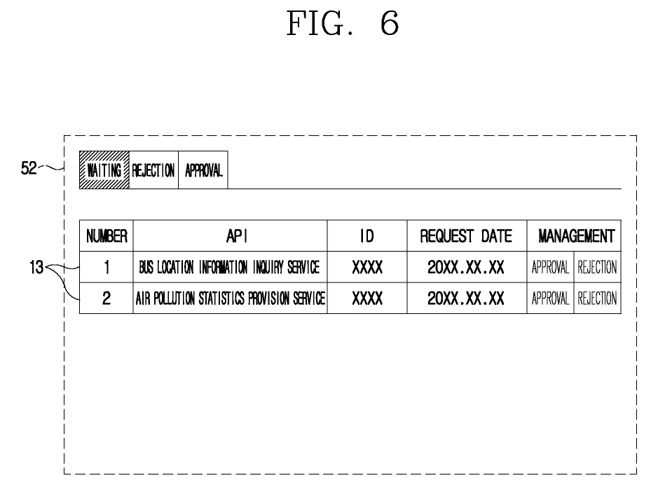

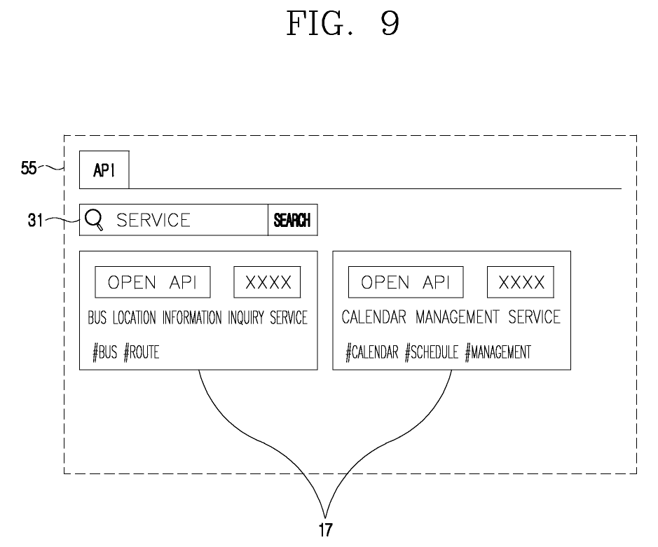

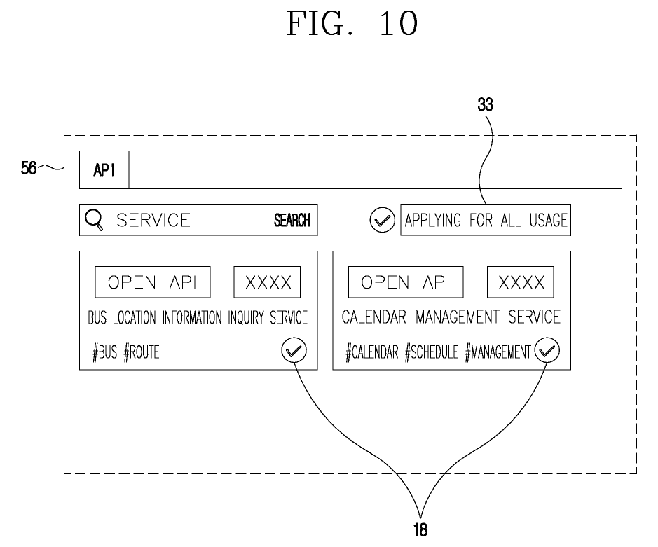

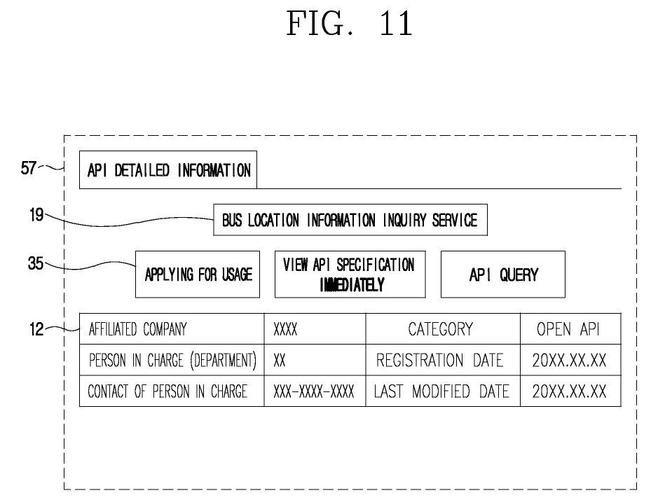

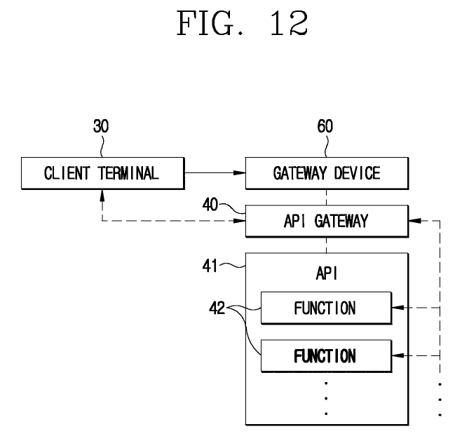

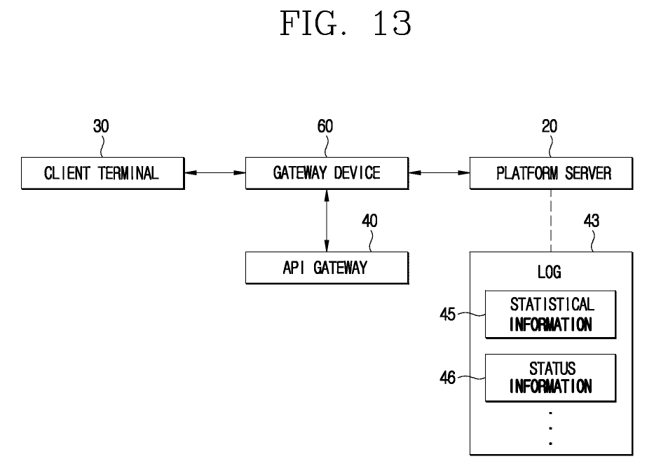

FIG. 2 is a flowchart illustrating a solution provision method according to the present invention. FIG. 3 illustrates an embodiment of selecting an administrator mode and a developer mode. FIG. 4 illustrates an embodiment of registering the developer account. FIG. 5 illustrates an embodiment of registering the API in the API product list. FIGS. 6 to 8 illustrate an embodiment of managing the API product list on the API platform. FIG. 9 illustrates an embodiment of searching for the API on the API platform. FIGS. 10 and 11 illustrate an embodiment of requesting the API subscription on the API platform. FIG. 12 illustrates an embodiment of constructing the API gateway. FIGS. 13 to 15 illustrate an embodiment of providing the log for the API gateway.

### API Registration

Referring to FIG. 2, the solution provision system 1 according to the present invention may transmit information related to the first application programming interface (API) for a specific service by allowing the administrator terminal to use the administrator account (S100).

Specifically, the administrator terminal may select the developer mode and the administrator mode through the user interface of the API platform provided by the platform server to the administrator account.

Referring to FIG. 3, for example, the platform server may output icons prepared in advance to select a developer mode 94 and an administrator mode 92 to user interfaces 91 and 93 provided to the administrator account through the API platform.

Accordingly, the administrator terminal may output the screen that can use the authority, the function, etc., that are granted by the API platform to the administrator account when the administrator terminal selects the administrator mode 92 through the user interface 91, and also output the screen that can use the authority, the function, etc., that are granted by the API platform to the developer account when the administrator terminal selects the developer mode 94 through the user interface 93.

That is, the administrator terminal may identify a request to register the login information to the API platform in the administrator mode 92 or identify the information related to the API uploaded to the API platform, and may upload the information related to the API to the API platform in the developer mode 94.

In this way, when the administrator terminal selects the developer mode through the user interface of the API platform, the administrator terminal may upload the information related to the API (e.g., the first API) implemented to provide a predetermined service to the platform server through the user interface provided by the API platform to the developer account.

For example, the administrator terminal may upload, to the platform server, information, such as instructions defined to call the function provided by the API based on the corresponding database, as the information related to the API implemented to provide the predetermined service to the platform server, along with an access route that can access a database (or API server) linked to the API.

In an embodiment, the API may be implemented to provide a bus location information inquiry service, an air pollution statistics provision service, a calendar management service, etc. Therefore, in the process of uploading the information related to the API for the bus location information inquiry service, the administrator terminal may upload, to the platform server, information such as instructions defined to call the functions provided by the corresponding API based on the database, along with an access route to the database in which bus information, stop information, route information by bus, etc., are stored.

In addition, in the process of uploading the information related to the API for the air pollution statistics provision service, the administrator terminal may upload, to the platform server, information such as instructions defined to call the function provided by the API based on the database, along with the access route to the database in which measurement location information, measurement time information, pollution type information, air pollution hazard information, etc., are stored.

In addition, in the process of uploading the information related to the API for the calendar management service, the administrator terminal may upload, to the platform server, information such as instructions defined to call the function provided by the API based on the database, along with the access route to the database in which schedule information, date information, time information, calendar information, schedule item information, etc., are stored.

In this case, the administrator terminal may generate bibliographic information for the API based on the user input, and upload the bibliographic information to the platform server along with information related to the API.

Meanwhile, the administrator terminal may set a traffic limit for the API for which the information was previously uploaded through the interface of the API platform 50. In this case, the administrator terminal may set a traffic limit for the corresponding API by specifying any one of the plurality of predetermined traffic limit levels, or set the traffic limit for the corresponding API based on the user input.

Referring back to FIG. 2, when the platform server registers the first API in the API product list and receives a registration request for a second API for a different service from the specific service from the developer terminal, the solution provision system 1 according to the present invention may register the second API in the API product list, and provide the API product list to the client terminal using the user interface (S200).

Specifically, the platform server may upload the information related to the API (e.g., the second API) implemented to provide a predetermined service to the platform server through the user interface of the API platform provided by the developer account.

Referring to FIG. 4, for example, the platform server 20 may receive information, such as instructions defined to call the function provided by the API 41 based on the corresponding database, as the information related to the API 41 implemented to provide the predetermined service from the developer terminal through the user interface provided by the API platform 50 to the developer account, along with the access route that can access the database (or API server) linked to the corresponding API 41.

In this case, as illustrated in FIG. 5, the platform server 20 may receive a registration request 96 for the developer account granted to the developer terminal through the interface 95 provided by the API platform 50 to the client account, and grant authority corresponding to the developer account to the login information for the corresponding client terminal according to the registration request.

Therefore, the platform server 20 may provide a screen corresponding to a developer mode 98 through the user interface 97 provided by the API platform to the developer terminal 39, which is registered with the developer account, and thus receive the information related to the API 41 from the developer terminal 39. In addition, the platform server 20 may generate the bibliographic information for the API 41 based on the user input from the developer terminal 39, and match the bibliographic information to the information related to the API 41.

In addition, the platform server 20 may set the traffic limit for the API 41 for which the information was previously received based on the user input from the developer terminal 39. In this case, the platform server 20 may set the traffic limit for the corresponding API 41 by specifying any one of the plurality of predetermined traffic limit levels based on the user input from the developer terminal 39 or set the traffic limit specified by the developer terminal.

Alternatively, when the platform server 20 receives the information related to the API 41 from the developer terminal, the platform server 20 may specify different traffic limits for the corresponding API 41 according to the authority level matched to the developer account. In this case, the authority level may be set to distinguish multiple developer accounts into different levels, and in one embodiment, the platform server 20 may distinguish the developer accounts into levels 1 to 3 and classify the login information for each developer account into groups for each level.

Therefore, when the platform server 20 receives the API 41 from the developer terminal 39, the platform server 20 may identify the level corresponding to the login information for corresponding developer terminal 39 and specify the predetermined traffic limit according to the identified level. In this case, the traffic limit may be set to a different level for each group.

Furthermore, when the administrator terminal selects the administrator mode through the user interface of the API platform, the administrator terminal may identify the information related to the API (e.g., the first API and the second API) uploaded to the platform server, determine whether to approve the uploaded API, and register the API for which the approval has been determined in the API product list, through the user interface provided by the API platform to the administrator account.

Referring to FIG. 6, for example, when the platform server receives the information related to the API from the administrator terminal or the developer account, the platform server may request the approval for the corresponding API from the administrator account. To this end, the platform server may provide the bibliographic information uploaded for the corresponding API to the administrator account. In addition, the platform server may provide the administrator account providing the information related to the corresponding API or the login information for the developer account to the administrator account, and may also provide the status information generated for the corresponding API to the administrator account.

Therefore, the administrator terminal may identify information 13 related to the API uploaded to the platform server through a user interface 52 provided by the API platform to the administrator account. That is, the administrator terminal may identify the bibliographic information and the status information for the API, and may also identify the login information corresponding to the administrator account or the developer account that uploads the API.

Accordingly, the administrator terminal may determine whether to approve the specific API based on the user input. In this case, the platform server may register the corresponding API in the API product list when the platform server receives an approval signal for the specific API from the administrator terminal, and may reject the approval for the corresponding API when the platform server receives a rejection signal for the specific API.

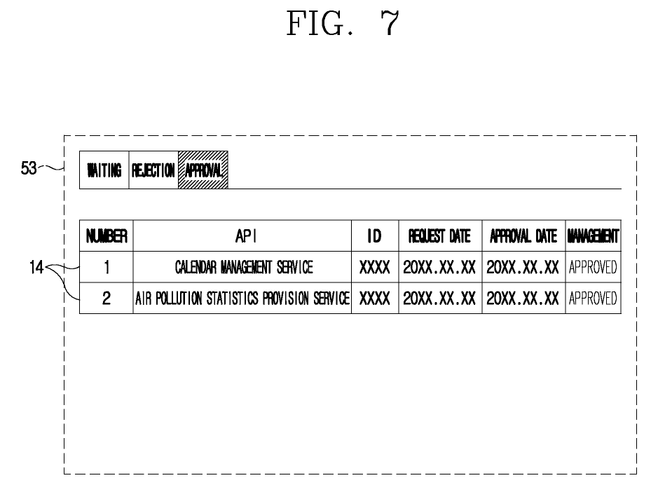

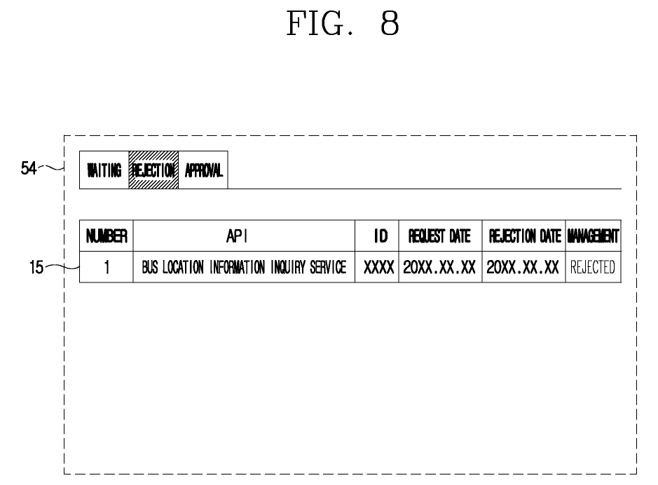

Accordingly, the platform server may provide the information related to the plurality of APIs 14 registered in the API product list by determining whether to approve the API, through the user interface 53 provided to the administrator account, as illustrated in FIG. 7, or provide information related to an API whose approval has been rejected, through the user interface 54 provided to the administrator account, as illustrated in FIG. 8.

In this way, the platform server may register the information related to the approved API in the API product list, and provide a list of approved APIs to the client account through the API platform.

In this case, the platform server may generate registration information corresponding to the approved API and register the corresponding API in the API product list. Here, the registration information may include a registration number, a product number, etc., for the API product list. In addition, the platform server may provide the list of APIs whose approval has been rejected through the API platform.

As another example, when the information related to the API is uploaded from the administrator account or the developer account, the platform server may perform a test process on the corresponding API to measure the status information. This test process may be implemented so that the platform server automatically executes the access route or instructions defined for the corresponding API, and measures a response speed and an error rate according to the execution result.

Therefore, the platform server may identify whether the status information for the specific API satisfies the predefined conditions, and register the corresponding API in the API product list when the corresponding API satisfies the predefined condition according to the identification result. Here, the predetermined conditions may include conditions for the response speed, the error rate, etc., for the corresponding API.

That is, based on the status information generated according to the test process, when the response speed is faster than a predetermined reference response speed and the error rate is lower than a predetermined reference error rate, the platform server may register the corresponding API in the API product list, and when the response speed is slower than the reference response speed or the error rate is higher than the reference error rate, may reject the approval for the corresponding API.

In this way, the platform server may register the approved API in the API product list. To this end, the platform server may generate registration information corresponding to the approved API and register the corresponding API in the API product list. Here, the registration information may include the registration number, the product number, etc., for the API product list.

In this way, the platform server may provide the API product list through the user interface provided by the API platform to the client account.

### Gateway Construction

Referring back to FIG. 2, the solution provision system 1 according to the present invention may provide the subscription list indicating at least one of the first API and the second API for which the subscription is requested to the gateway device based on the subscription request for at least one of the first API and the second API received by the platform server from the client terminal (S300).

Specifically, the platform server may receive search information from the client terminal through the user interface provided by the API platform to the client account, and specify the API corresponding to the received search information.

Referring to FIG. 9, for example, the platform server may generate search information 31 indicating a keyword or a word for an API 17 to be searched in the API product list based on a user input from the user interface 55 provided by the API platform to the client account.

Accordingly, the platform server may specify the API 17 which the bibliographic information including the keyword or the word corresponding to the search information 31 among the plurality of APIs registered in the API product list matches.

Accordingly, the platform server may provide at least one of bibliographic information and status information related to a specific API 17 based on the search information 31 to the client terminal through the user interface 55 provided by the API platform to the client account.

In this regard, when the sorting mode for the API product list is selected through the user interface provided by the API platform to the client account, the platform server may specify at least one of the plurality of APIs registered in the API product list based on a predetermined priority according to the selected sorting mode, and provide the information related to the specified API to the client terminal.

For example, the platform server may select the sorting mode for the number of times of subscription requests for the API product list. In this case, the platform server may specify at least one of the plurality of APIs registered in the API product list in order of the highest number of times of subscription requests, and provide information related to the previously specified API through the API platform.

In addition, the platform server may select a sorting mode for the most recent registration date for the API product list, specify at least one of the plurality of APIs registered in the API product list in the order that a date registered in the API product list is close to the latest date, and provide the information related to the previously specified API through the API platform.

Furthermore, when the subscription request for at least one API is received based on the API product list, the platform server may provide the information related to at least one API for which the subscription is requested and the information related to the corresponding client account through the user interface provided to the administrator account, thereby specifying whether to approve the subscription for the corresponding subscription request.

For example, when the subscription request for at least one of the plurality of APIs registered in the API product list is received through the user interface provided by the API platform server to the client account, the platform server may request the administrator account to approve the corresponding subscription request.

In this case, as illustrated in FIG. 10, the platform server may provide information 12 related to any one API 19 among the plurality of APIs registered in the API product list through the user interface 57 provided by the API platform to the client account, and receive a subscription request 35 for the corresponding API 19 based on the user input for the client terminal on the corresponding interface 57.

In addition, the platform server may provide a screen that can perform redundant selections so that a subscription request for two or more APIs 18 among the plurality of APIs registered in the API product list can be made through a user interface 56 provided by the API platform to the client account as illustrated in FIG. 11. In this case, the platform server may receive a subscription request 33 for two or more APIs 18 based on the user input for the client terminal on the interface 56.

Meanwhile, the platform server 20 may provide at least one of the bibliographic information and the status information generated for at least one API 41 corresponding to the subscription request to the administrator account. In addition, the platform server may provide the administrator account with the login information for the client account that transmits the subscription request for at least one API.

Therefore, the administrator terminal may identify the subscription request for at least one API requested to the platform server through the user interface provided by the API platform 52 to the administrator account, and determine whether to approve the subscription for at least one API based on the user input.

For another example, when the platform server receives the API subscription request for at least one API from the client terminal, the platform server may identify whether the client terminal requesting the API subscription satisfies the predetermined conditions, and approve the subscription request for at least one API based on the identification result.

In an embodiment, the predetermined conditions may be the number of concurrent API subscriptions allowed for each level that matches the login information for the client account. That is, the platform server may compare the number of concurrent API subscriptions allowed according to the level of the client account requesting the API subscription with the number of at least one API selected according to the API subscription request, approve the API subscription when the number of at least one API requested in advance is less than or equal to the number of current API subscriptions allowed, based on the comparison result, and reject the API subscription when the number of at least one API requested in advance is greater than the number of concurrent API subscriptions allowed.

In this case, the number of APIs compared with the number of concurrent API subscriptions allowed may include at least one of the number of at least one API corresponding to the API subscription request and the number of at least one API included in the API gateway constructed for the corresponding client account.

Furthermore, when the subscription request for at least one API is approved from the administrator terminal, the platform server may generate the subscription list based on the information related to at least one API according to the subscription request and transmit the subscription list to the gateway device.

For example, when the subscription request received from the client terminal is approved by the administrator terminal, the platform server may generate the subscription list using, as the information related to at least one API specified according to the subscription request, the information such as the access route that can access the database (or API server) linked to the API, the instructions defined to call the function provided by the API based on the corresponding database, etc.

Therefore, the subscription list may include the information such as the API name (or identification information), the access route to the database, and the instructions. In addition, the subscription list may include information related to the client account (or client terminal) that transmits the subscription request through the platform server.

Referring back to FIG. 2, the solution provision system 1 according to the present invention may include the gateway device that constructs the API gateway integrating at least one API based on the subscription list, and relay the communication connection between the client terminal and the plurality of API servers related to the first API and the second API (S400).

Specifically, the gateway device may perform the routing on at least one API for which the subscription is requested based on the subscription list received from the platform server, and construct the API gateway that integrates at least one API.

Referring to FIG. 12, for example, the gateway device 60 may perform the routing on at least one API 41 included in the subscription list. That is, the gateway device may construct the API gateway 40 including at least one API 41 by setting a route for the API gateway 40, a route for the API 41, and a route for each function 42 provided by the API 41.

To this end, the gateway device 60 may generate identification information corresponding to each of the API gateway 40, the API 41, and the functions 42 of the API 41, and sequentially list the identification information corresponding to each of the API gateway 40, the API 41, and the functions 42 to generate an access route (e.g., URL address) for at least one of API 41 and functions 42 provided through the API gateway 40, so the gateway device 60 may set a route for each of the plurality of functions 42 provided from at least one API 41 through the API gateway 40.

In an embodiment, when the gateway device 60 receives the subscription list for the APIs corresponding to each of the calendar management service, the bus location information inquiry service, and the air pollution statistics provision service from the platform server, the gateway device 60 may set a route for multiple services provided by each of the calendar management service and the air pollution statistics provision service.

That is, the gateway device 60 may set routes for schedule registration, schedule inquiry, schedule modification, calendar inquiry, schedule inquiry by schedule item, schedule inquiry by date, etc., that are the functions 42 provided by the calendar management service, set routes for stop registration, bus registration, route registration by bus, bus arrival time inquiry by stop, route inquiry by bus, etc., that are the functions 42 provided by the bus location information inquiry service, and set routes for pollution information registration, air pollution hazard registration, measurement location registration, pollution information inquiry, air pollution hazard inquiry, etc., that are the functions 42 provided by the air pollution statistics provision service.

In this case, the gateway device 60 may generate API_Gateway as the identification information for the API gateway 40, and generate calendar, bus, and Air_Pollution as the identification information for each of the calendar management service, the bus location information inquiry service, and the air pollution statistics provision service.

In addition, the gateway device 60 may generate Schedule_Reg, ScheduleView, ScheduleRev, Calendar_View, Schedule_View_item, and Schedule_View_day as identification information for schedule registration, schedule inquiry, schedule modification, calendar inquiry, schedule inquiry for each schedule item, and schedule inquiry by date, respectively, that are the functions 42 of the calendar management service, generate Station_Reg, BusReg, RouteReg, Time_ViewStation, and Route_View_Bus as identification information for stop registration, bus registration, route registration by bus, bus arrival time inquiry by stop, and route inquiry by bus, respectively, that are the functions 42 of the bus location information inquiry service, and generate Pollution_Reg, Hazard_Reg, Position_Reg, PollutionView, and Hazard_View as identification information for pollution information registration, air pollution hazard registration, measurement location registration, pollution information inquiry, and air pollution hazard inquiry, respectively, that are the functions 42 of the air pollution statistics provision service.

Accordingly, the gateway device 60 may set API_Gateway.Calendar.ScheduleReg as a route for the schedule registration function of the calendar management service, API_Gateway.Calendar.Schedule_View_item as a route for the schedule inquiry function for each schedule item, API_Gateway.Bus.RouteReg as a route for the route registration function by bus of the bus location information inquiry service, API_Gateway.Bus.TimeView_Station as a route for the bus arrival time inquiry by stop, API_Gateway.AirPollution.Hazard_Reg as a route for the air pollution hazard registration function of the air pollution statistics provision service, and API_Gateway.AirPollution.Pollution_View as a route for the pollution information inquiry function.

In this case, it goes without saying that the gateway device 60 may generate identification information, routes, etc., in different ways or forms according to the embodiment.

In addition, the gateway device 60 may grant the access authority to the previously constructed API gateway 40 to the client terminal 30 requesting the API subscription based on the subscription list. In addition, the gateway device 60 may grant the access authority to at least one API 41 selected according to the API subscription request to the previously constructed API gateway 40.

That is, the gateway device 60 may construct the API gateway 40 by setting the route for the functions 42 provided by at least one API 41, and grant the access authority from the client terminal 30 to the previously constructed API gateway 40 and the access authority from the API gateway 40 to at least one API 41 included in the API gateway 40.

Furthermore, when two or more functions are selected from among the plurality of functions provided by the at least one API included in the API gateway from the client terminal through the platform server, the gateway device may generate an additional route so that the two or more selected functions are called together based on common information from the two or more functions previously selected.

For example, when the functions corresponding to the schedule inquiry, the bus arrival time inquiry by stop, and the route inquiry by bus are selected from the client terminal requesting the API subscriptions for the calendar management service and the bus location information inquiry service, the gateway device may generate the additional route in which the schedule inquiry, the bus arrival time inquiry by stop, and the route inquiry by bus are called together based on the location information that is the common information from the schedule inquiry, the bus arrival time inquiry by stop, and the bus route inquiry by bus.

In this case, the gateway device may specify a function used as a reference among the two or more functions previously selected based on the user input, and generate the additional route so that other functions excluding the function used as the reference among the two or more functions are called based on the common information corresponding to the reference function.

That is, when a schedule inquiry function is selected as the reference function from the client terminal, the gateway device may call the bus arrival time inquiry by stop and route inquiry by bus functions based on the location information corresponding to the schedule inquiry function to generate the additional route.

Therefore, the gateway device may identify a departure and a destination of the schedule based on the schedule inquiry result according to the schedule inquiry function, and generate an additional route to provide a bus route and a bus time from the departure to the destination based on the bus arrival time inquiry by stop and route inquiry by bus functions.

Furthermore, the gateway device may identify the task requested from the client terminal, transmit the corresponding task to the API server corresponding to the identified task, and acquire the result for the previously transmitted task from the corresponding API server. Accordingly, the gateway device may provide the previously acquired result to the client terminal.

In this regard, as illustrated in FIG. 13, the gateway device 60 may identify the access of the client terminal 30 to the previously constructed API gateway 40, generate a log 43 and transmit the generated log 43 to the platform server 20. Therefore, the platform server 20 may receive the log 43 for the API gateway from the gateway device 60, and generate status information 46 and statistical information 45 for at least one API 41 included in the API gateway 40 based on the corresponding log 43.

For example, the gateway device may record a call signal requesting the task from the client terminal to the API gateway, an API call command requested from the API gateway to the API according to the corresponding signal, a call response provided from the API to the API gateway according to the API call command, and a response signal provided from the API gateway to the client terminal to generate the log. In this case, the gateway device may transmit the generated log to the platform server.

Therefore, the platform server may generate the statistical information for the client terminal based on the call signal and the response signal appearing from the log, and generate the status information for at least one API included in the API gateway based on the API call command and the call response.

That is, the platform server may calculate the number of times the task is requested from the API gateway per predetermined time unit (e.g., 1 hour, 1 day, 1 year, etc.) from the client terminal based on the call signal and the response signals appearing from the log to generate the statistical information.

In addition, the platform server may calculate the response time of each at least one API included in the API gateway based on the API call command and the call response, and calculate the ratio of the call response when an error occurs to the total call response provided per predetermined time unit from the call response to generate an error rate, thereby generating the status information for each API.

Furthermore, the platform server may provide the status information and the statistical information for at least one API included in the API gateway through the API platform, generate an API status report related to the API gateway, the status information and the statistical information based on the user input from the client terminal, and provide the previously generated API status report to the client terminal through the API platform.

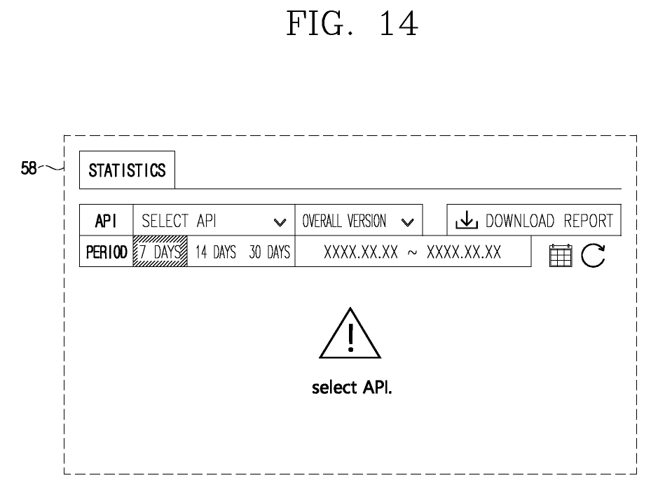

Referring to FIG. 14, for example, when the platform server receives the user input requesting the API status report from the client terminal through the API platform 58, the platform server may generate the API status report according to a predefined format using the statistical information for the API gateway, and the status information for each at least one API, along with the information related to at least one API included in the API gateway, and provide the API status report to the client terminal that previously requests the API status report.

In this case, the platform server may specify a period for the statistical information and the status information to be included in the API status report based on the user input from the client terminal, and also specify the API to be included in the API status report.

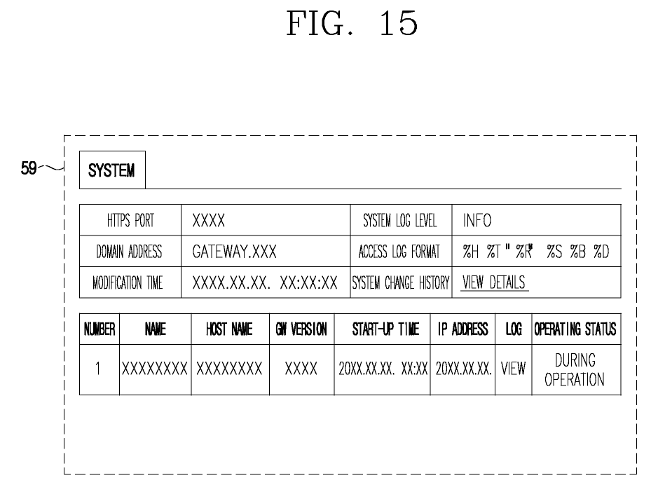

Meanwhile, as illustrated in FIG. 15, the platform server may provide the information for the API gateway to the client terminal through the user interface 59 provided by the API platform.

Through the configurations as described above, the solution provision system 1 according to the present invention may easily use various APIs by subscribing to the APIs provided by the developer and administrator through the API platform.

In addition, the solution provision system 1 according to the present invention may perform the routing on at least one API subscribed by the API platform, construct the API gateway, and provide the constructed API gateway, thereby enabling the efficient use of the API.

### Overall Contents of Gateway Device - 51 Cases

Furthermore, the present invention described above may stably process the predetermined task requested by the API gateway from the client terminal through the gateway device.

Hereinafter, the gateway device applied to the present invention will be described in more detail with reference to FIGS. 16A and 16B. FIGS. 16A and 16B illustrate the gateway device according to the present invention.

Referring to FIGS. 16A and 16B, the gateway device 60 according to the present invention may construct the API gateway 40 that integrates at least one API 41, generate a plurality of replication gateways 40a that operate identically to the corresponding API gateway 40, and allocate the task requested from the client terminal 30 for at least one API 41 to any one of the plurality of replication gateways 40a.

In this regard, each of the plurality of replication gateways 40a may be the API gateway 40 for at least one API 41 implemented in the same manner. In this case, the API gateway 40 may be implemented to integrate and manage at least one API 41. To this end, the gateway device 60 may perform the routing on at least one API 41 to construct the API gateway 40 that integrates at least one API 41. That is, the gateway device 60 may grant the access authority to access at least one API 41 through the API gateway 40 from the client terminal 30, and may set the route for the functions provided by each of the at least one API 41.

To this end, the gateway device 60 according to the present invention may include a communication unit 61, a storage unit 62, and a control unit 63. The communication unit 61, the storage unit 62, and the control unit 63 may be connected to each other through a system bus, a network, or other connection mechanisms.

The communication unit 61 may be connected to the client terminal 30 via a wireless or wired network. Accordingly, the communication unit 61 may receive a request signal requesting the task for the API 41 from the client terminal 30. Accordingly, the communication unit 61 may transmit a task result processed through the API gateway 40 in response to the task requested from the client terminal 30.

In addition, the communication unit 61 may be connected to a separate platform server via a wireless or wired network. Accordingly, the communication unit 61 may receive information related to at least one API 41 to construct the API gateway 40 from the platform server.

The communication unit 61 may include one or more devices that provide one or more wireless interface(s) and/or one or more wired interface(s) that can be configured to communicate through a network. In addition, the communication unit 61 may be configured to provide reliable security and/or authenticated communication.

In addition, the storage unit 62 may store instructions and information necessary for the operation of the gateway device 60 according to the present invention. For example, the storage unit 62 may store the information (e.g., route, authority, function, etc.) related to the plurality of APIs 41 prepared in advance, and the storage unit 62 may also store information (e.g., route, authority, etc.) related to the plurality of replication gateways 40a. In addition, the storage unit 62 may store the logs recorded for each of the plurality of replication gateways 40a, and store the status information generated based on the logs. That is, the storage unit 62 may store the information such as the task quantity, the error response rate, and the waiting time for each of the plurality of replication gateways 40a.

The storage unit 62 is data storage, and may include one or more non-transitory computer-readable storage media that may be read and/or accessed by the control unit 63 (for example, at least one of the one or more processors).

One or more non-transitory computer-readable storage media may include volatile and/or non-volatile storage components such as optical, magnetic, organic or other memory or disk storage devices. In some examples, the storage unit 62 may be implemented using a single physical device (e.g., one optical, magnetic, organic, or other memory or disk storage device), while in other examples, the storage unit 62 may be implemented using two or more physical devices.

In addition, the storage unit 62 may include computer-readable instructions and additional data. The storage unit 62 may include storage necessary to perform at least some of methods, scenarios and techniques described herein and/or at least some of the functions of the devices and networks.

The control unit 63 may control the overall operation of the gateway device 60 according to the present invention. That is, the control unit 63 may construct the API gateway 40 that integrates at least one API 41, generate the plurality of replication gateways 40a that operate identically to the corresponding API gateway 40, and allocate the task requested from the client terminal 30 for at least one API 41 to any one of the plurality of replication gateways 40a.

Specifically, the control unit 63 may specify at least one API 41 among the plurality of APIs prepared in advance. In this case, the control unit 63 may receive the subscription list indicating the information related to at least one API 41 for which the subscription is requested by the client terminal 30 from the platform server providing the API platform, and may specify at least one API 41 based on the subscription list.

Accordingly, the control unit 63 may construct the API gateway 40 that relays the communication connection between the client terminal 30 and the API server based on at least one specified API 41, and generate the plurality of replication gateways 40a that operate identically to the API gateway 40.

To this end, the control unit 63 may perform the routing on at least one API 41 for which the subscription is requested based on the subscription list received from the platform server, and construct the API gateway 40 that integrates at least one API 41.

Furthermore, when two or more functions are selected from among the plurality of functions provided by the at least one API 41 included in the API gateway 40 from the client terminal 30 through the platform server, the control unit 63 may generate the additional route so that the two or more selected functions are called together based on the common information from the two or more functions previously selected.

Meanwhile, the control unit 63 may generate the plurality of replication gateways 40a having different routes from the previously constructed API gateway 40 based on the subscription list received from the platform server. In this case, the plurality of replication gateways may include the previously constructed API gateway 40.

Accordingly, the control unit 63 may control the plurality of replication gateways 40a based on the task requested from the client terminal 30 for the plurality of functions provided by the API server.

To this end, the control unit 63 may allocate the task requested for at least one API 41 to one of the plurality of replication gateways 40a based on the task allocation algorithm prepared in advance.

In addition, the control unit 63 may identify the status information for each of the plurality of replication gateways 40a, select any one of the plurality of replication gateways 40a based on the identification result, and process the task requested from the client terminal 30 using the selected one of the replication gateways 40a.

The control unit 63 is one or more processors, and may include one or more processors, and the processors may include one or more general-purpose processors and/or one or more special-purpose processors (e.g., a digital signal processor, a tensor processing unit (TPU), a graphics processing unit (GPU), a neural network processing unit (NPU), an application-specific integrated circuit, an application-specific integrated circuit (ASIC), etc.). The control unit 63 may be configured to execute the computer-readable instructions included in the storage unit 62 and/or other commands described herein.

Meanwhile, the gateway device 60 may be a computing device including one or more sensors and/or a power system. Here, one or more sensors may be configured to measure conditions within the computing device and/or conditions of the computing device environment and provide data about these conditions. The power system may include one or more batteries and/or one or more external power interfaces for providing power to the computing device.

Based on the configuration of the gateway device 60 described above, the gateway control method will be described in more detail below.

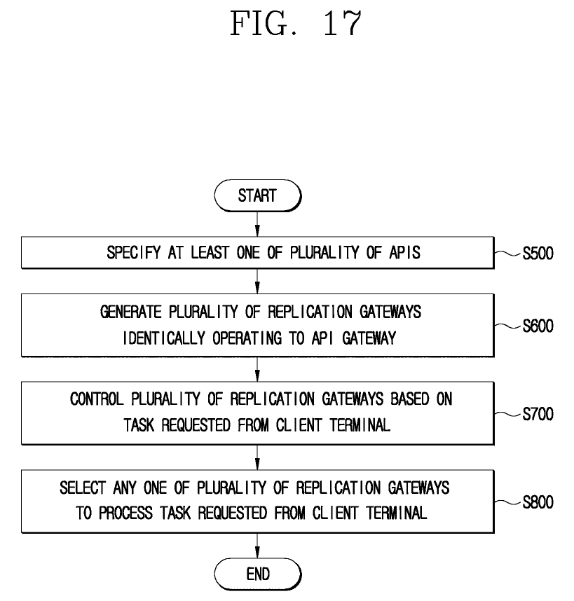

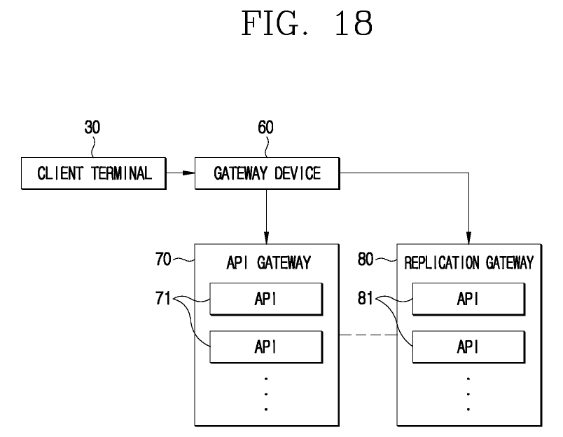

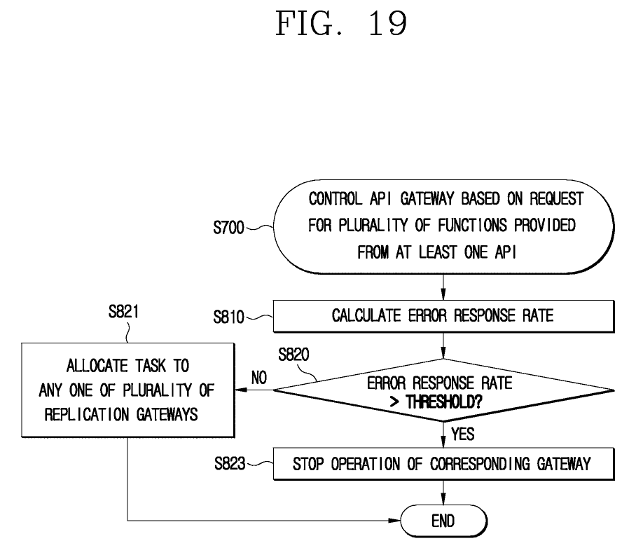

FIG. 17 is a flowchart illustrating an API gateway control method according to the present invention. FIG. 18 illustrates an embodiment of generating the replication gateway. FIGS. 19 to 21 are flowcharts illustrating an embodiment of a method of controlling a replication gateway.

### API Specification

Referring to FIG. 17, the gateway device 60 according to the present invention may specify at least one of the plurality of APIs prepared in advance (S500).

Specifically, the gateway device 60 may receive the subscription list indicating the information related to at least one API for which the subscription is requested by the client terminal from the platform server providing the API platform, and may specify at least one API based on the subscription list.

For example, the platform server may be implemented to receive the API from the developer terminal or the administrator terminal, register the received API in the API product list, and provide the API product list through the interface provided by the API platform to the client account.

Here, the API platform may be implemented as a website or an application that may be accessed by the user terminal, and may be implemented to register an API implemented to provide a predetermined service or request a subscription for a specific API.

Therefore, the platform server may receive different APIs from the developer terminal or the administrator terminal through the interface provided by the API platform to the developer account, and register the previously received APIs in the API product list. In addition, the platform server may receive the subscription request for at least one of the plurality of APIs included in the API product list from the client terminal through the interface provided by the API platform to the client account, generate the subscription list indicating at least one API for which the subscription is requested, and transmit the generated subscription list to the gateway device 60.

To this end, the platform server may generate the subscription list using, as the information related to at least one API specified according to the subscription request, the information such as the access route that can access the database (or API server) linked to the API, the instructions defined to call the function provided by the API based on the corresponding database, etc.

Therefore, the subscription list may include the information such as the API name (or identification information), the access route to the database, and the instructions. In addition, the subscription list may include the information related to the client account (or client terminal) that transmits the subscription request through the platform server.

In this way, the gateway device 60 may specify at least one API based on the subscription list received from the platform server, and identify the information, such as the API name (or identification information), the access route to the database, and the instructions, as the information related to at least one specified API.

### Gateway Construction

The gateway device 60 according to the present invention may construct the API gateway that relays the communication connection between the client terminal and the API server based on at least one specified API, and generate the plurality of replication gateways that operate identically to the API gateway (S600).

Specifically, the gateway device 60 may perform the routing on at least one API for which the subscription is requested based on the subscription list received from the platform server, and construct the API gateway that integrates at least one API.

Referring back to FIG. 12, for example, the gateway device 60 may perform the routing on at least one API 41 included in the subscription list. That is, the gateway device 60 may construct the API gateway 40 including at least one API 41 by setting a route for the API gateway 40, a route for the API 41, and a route for each function 42 provided by the API 41.

To this end, the gateway device 60 may generate identification information corresponding to each of the API gateway 40, the API 41, and the functions 42 of the API 41, and sequentially list the identification information corresponding to each of the API gateway 40, the API 41, and the functions 42 to generate an access route (e.g., URL address) for at least one API 41 and functions 42 provided through the API gateway 40, so the gateway device 60 may set a route for each of the plurality of functions 42 provided from at least one API 41 through the API gateway 40.

In an embodiment, when the gateway device 60 receives the subscription list for the APIs corresponding to each of the calendar management service, the bus location information inquiry service, and the air pollution statistics provision service from the platform server, the gateway device 60 may set a route for multiple services provided by each of the calendar management service and the air pollution statistics provision service.

That is, the gateway device 60 may set routes for schedule registration, schedule inquiry, schedule modification, calendar inquiry, schedule inquiry by schedule item, schedule inquiry by date, etc., that are the functions 42 provided by the calendar management service, set routes for stop registration, bus registration, route registration by bus, bus arrival time inquiry by stop, route inquiry by bus, etc., that are the functions 42 provided by the bus location information inquiry service, and set routes for pollution information registration, air pollution hazard registration, measurement location registration, pollution information inquiry, air pollution hazard inquiry, etc., that are the functions 42 provided by the air pollution statistics provision service.

In this case, the gateway device 60 may generate API_Gateway as the identification information for the API gateway 40, and generate calendar, bus, and Air_Pollution as the identification information for each of the calendar management service, the bus location information inquiry service, and the air pollution statistics provision service.

In addition, the gateway device 60 may generate Schedule_Reg, ScheduleView, ScheduleRev, Calendar_View, Schedule_View_item, and Schedule_View_day asidentification information for schedule registration, schedule inquiry, schedule modification, calendar inquiry, schedule inquiry for each schedule item, and schedule inquiry by date, respectively, that are the functions 42 of the calendar management service, generate Station_Reg, BusReg, RouteReg, Time_ViewStation,and Route_View_Bus as identification information for stop registration, bus registration, route registration by bus, bus arrival time inquiry by stop, and route inquiry by bus, respectively, that are the functions 42 of the bus location information inquiry service and generate Pollution_Reg, Hazard_Reg, Position_Reg, PollutionView, and Hazard_View as identification information for pollution information registration, air pollution hazard registration, measurement location registration, pollution information inquiry, and air pollution hazard inquiry, respectively, that are the functions 42 of the air pollution statistics provision service.

Accordingly, the gateway device 60 may set API_Gateway.Calendar.ScheduleReg as a route for the schedule registration function of the calendar management-service, API_Gateway.Calendar.Schedule_View_item as the route for the schedule inquiry function for each schedule item, API_Gateway.Bus.RouteReg as the route for the route registration function by bus of the bus location information inquiry service API_Gateway.Bus.TimeView_Station as the route for the bus arrival time inquiry by stop, API_Gateway.AirPollution.Hazard_Reg as the route for the air pollution hazard registration function of the air pollution statistics provision service, and API_Gateway.AirPollution. Pollution_View as the route for the pollution information inquiry function.

In this case, it goes without saying that the gateway device 60 may generate identification information, routes, etc., in different ways or forms according to the embodiment.

In addition, the gateway device 60 may grant the access authority to the previously constructed API gateway 40 to the client terminal 30 requesting the API subscription based on the subscription list. In addition, the gateway device 60 may grant the access authority to at least one API 41 selected according to the API subscription request to the previously constructed API gateway 40.

That is, the gateway device 60 may construct the API gateway 40 by setting the route for the functions 42 provided by at least one API 41, and grant the access authority from the client terminal 30 to the previously constructed API gateway 40 and the access authority from the API gateway 40 to at least one API 41 included in the API gateway 40.

Furthermore, when two or more functions are selected from among the plurality of functions provided by the at least one API included in the API gateway from the client terminal through the platform server, the gateway device 60 may generate an additional route so that the two or more selected functions are called together based on the common information from the two or more functions previously selected.

For example, when the functions corresponding to the schedule inquiry, the bus arrival time inquiry by stop, and the route inquiry by bus are selected from the client terminal requesting the API subscriptions for the calendar management service and the bus location information inquiry service, the gateway device 60 may generate the additional route in which the schedule inquiry, the bus arrival time inquiry by stop, and the route inquiry by bus are called together based on the location information that is the common information from the schedule inquiry, the bus arrival time inquiry by stop, and the bus route inquiry by bus.

In this case, the gateway device 60 may specify a function used as a reference among the two or more functions previously selected based on the user input, and generate the additional route so that other functions excluding the function used as the reference among the two or more functions are called based on the common information corresponding to the reference function.

That is, when a schedule inquiry function is selected as the reference function from the client terminal, the gateway device 60 may call the bus arrival time inquiry by stop and route inquiry by bus functions based on the location information corresponding to the schedule inquiry function to generate the additional route.

Therefore, the gateway device 60 may identify a departure and a destination of the schedule based on the schedule inquiry result according to the schedule inquiry function, and generate an additional route to provide a bus route and a bus time from the departure to the destination based on the bus arrival time inquiry by stop and route inquiry by bus functions.

Furthermore, as illustrated in FIG. 18, the gateway device 60 may generate a plurality of replication gateways 80 having different routes from the previously constructed API gateway 70 based on the subscription list received from the platform server. In this case, the plurality of replication gateways 80 may include the previously constructed API gateway 70. That is, each of the plurality of replication gateways 80 may be connected to at least one API 81 that is identical to at least one API 71 connected to the API gateway 70.

For example, the gateway device 60 may include a plurality of sub-gateway devices having different routes and a main gateway device controlling the plurality of sub-gateway devices.

Therefore, the gateway device 60 may transmit the subscription list received from the platform server to the plurality of sub-gateway devices having different routes to generate the plurality of replication gateways that operate identically.

That is, each of the plurality of sub-gateway devices may receive the same subscription list from the platform server, and thus, each of the plurality of sub-gateway devices may perform the routing on at least one API for which the subscription is requested based on the subscription list, thereby constructing the API gateway that integrates at least one API. In this case, it may be understood that the API gateway constructed in each of the plurality of sub-gateway devices is the replication gateway.

In addition, the main gateway device may be designated with routes for the plurality of sub-gateway devices. That is, when the task for the predetermined API is requested from the client terminal, the main gateway device may be implemented to allocate the corresponding task to at least one of the plurality of sub-gateways based on the routes on the plurality of sub-gateway devices.

For another example, the gateway device 60 may construct a single gateway device or the plurality of replication gateways having different internal routes in a cloud-based network, based on the subscription list received from the platform server.

That is, the gateway device 60 may set different identification information between the replication gateways. In an embodiment, the gateway device 60 may set API_Gateway1 as the identification information for any one of the plurality of replication gateways and set API_Gateway2 as the identification information for another replication gateway. In this case, the gateway device 60 may distribute and process the task allocated to the API gateway by specifying the identification information corresponding to any one of the plurality of replication gateways in the route for the task requested for the specific API from the client terminal.

In another embodiment, the gateway device 60 may designate different internal IP addresses or port numbers for each of the plurality of replication gateways. In this case, the gateway device 60 may designate an internal IP address or port number corresponding to the API gateway 70 or the replication gateway 80 for a task requested from the client terminal 30 to a specific API 71 and 81 to distribute and process the task allocated to the API gateway 70.

### API task processing

Referring back to FIG. 17, the gateway device 60 according to the present invention may control the plurality of replication gateways based on the task requested from the client terminal for the plurality of functions provided by the API server (S700).

Specifically, the gateway device 60 may allocate the task requested for at least one API to one of the plurality of replication gateways based on the task allocation algorithm prepared in advance.

For example, the gateway device 60 may control whether to allocate the task to each of the plurality of replication gateways based on the task quantity requested from the client terminal. That is, the gateway device 60 may compare the task quantity requested per predetermined time unit from the client terminal with a predetermined reference value, and control whether to allocate the task to each of the plurality of replication gateways based on the comparison result.

Accordingly, when the task quantity requested from the client terminal per predetermined time unit is less than the predetermined reference value, the gateway device 60 may allocate the task requested from the client terminal to only predetermined any one of the plurality of replication gateways. In addition, when the task quantity requested from the client terminal per predetermined time unit is more than the predetermined reference value, the gateway device 60 may allocate the task requested from the client terminal to each of the plurality of replication gateways using a task allocation algorithm such as round robin, least connections, least response time, and threshold-based.

Meanwhile, the gateway device 60 according to the present invention may identify the status information for each of the plurality of replication gateways, select any one of the plurality of replication gateways based on the identification result, and process the task requested from the client terminal using the selected one of the replication gateways (S800).

Referring to FIG. 19, for example, the gateway device 60 may control the operation of each of the plurality of replication gateways based on the error response rate for each of the plurality of replication gateways.

That is, the gateway device 60 may calculate the error response rate for each of the plurality of replication gateways (S810). To this end, the gateway device 60 may calculate the ratio of the task quantity requested from the client terminal to the gateway device 60 (e.g., the main gateway device) and the error occurrence amount in the response signal transmitted from the gateway device 60 to the client terminal to calculate the error response rate.

Accordingly, the gateway device 60 may compare the error response rate with a predetermined threshold (S820) and control the operation of each of the plurality of replication gateways based on the comparison result.

That is, the gateway device 60 may allocate the task requested for at least one API to one of the plurality of replication gateways based on the task allocation algorithm when the error response rate is lower than the predetermined threshold (S821), and may stop the operation of the corresponding gateway (e.g., any one of the plurality of replication gateways) when the error response rate is higher than the predetermined threshold (S823).

In this case, the gateway device 60 may re-execute the stopped gateway after a predetermined time interval, and initialize the replication gateway when the error response rate for the tasks corresponding to the predetermined number of tasks for the re-executed replication gateways is higher than the predetermined threshold.

Here, the gateway device 60 may reset the access route for at least one API for which the API subscription is requested from the client terminal, or change the identification information for the corresponding replication gateway to perform the initialization.

In addition, the gateway device 60 may re-execute the replication gateway when the initialization of the replication gateway is performed, remove the replication gateway when the error response rate for the tasks corresponding to the predetermined number of tasks for the re-executed replication gateway is higher than the predetermined threshold, and generate a new replication gateway using any one of the plurality of other replication gateways.

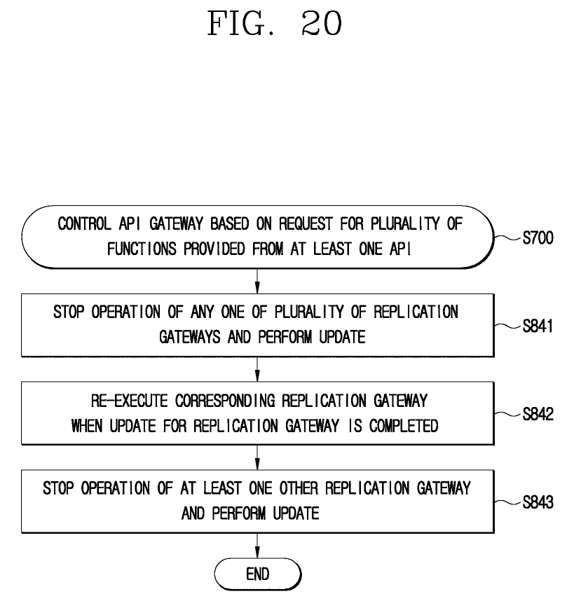

Referring to FIG. 20, for another example, when an update is required for the API gateway, the gateway device 60 may sequentially perform updates for each of the plurality of replication gateways.

That is, when the update is required for the API gateway, the gateway device 60 may stop the operation of any one of the plurality of replication gateways and perform the update (S841). In this case, the gateway device 60 may process the task from the client terminal through at least one other replication gateway.

Next, when the update for any one replication gateway for which the update was previously performed is completed, the gateway device 60 may re-execute the corresponding replication gateway (S842), and stop the operation of at least one other replication gateway and perform the update (S843). In this case, the gateway device 60 may process the task from the client terminal through the updated gateway.

In this regard, when the access route for at least one API included in the API gateway is changed to another route or the instructions for calling the function for at least one API are changed to another instruction, the corresponding API may be updated on the gateway device 60.

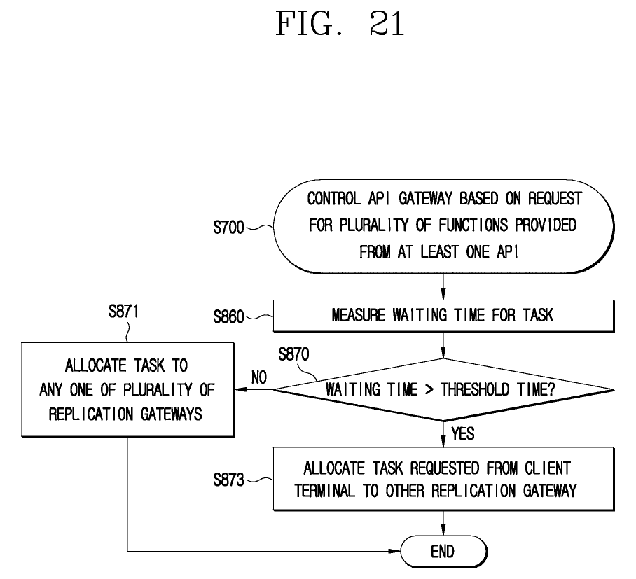

Referring to FIG. 21, for another example, the gateway device 60 may control the operation of each of the plurality of replication gateways based on the waiting time of each of the plurality of replication gateways.

That is, the gateway device 60 may measure the waiting time for the task requested from the client terminal to each of the plurality of replication gateways (S860). To this end, the gateway device 60 may calculate a time interval from the time at which the call signal is received from the client terminal to each of the plurality of replication gateways to the time at which the response signal is transmitted from each of the plurality of replication gateways to the client terminal in response to the corresponding call signal.

Accordingly, the gateway device 60 may compare a waiting time for a specific gateway (e.g., any one of the plurality of replication gateways) with a predetermined threshold time (S870), and control an operation for each of the plurality of replication gateways based on the comparison result.

That is, the gateway device 60 allocates the task requested for at least one API to any one of the plurality of replication gateways based on the task allocation algorithm when the waiting time for the specific gateway (e.g., any one of the plurality of replication gateways) is shorter than the predetermined threshold time (S871), and allocate the task requested from the client terminal to replication gateways other than the corresponding replication gateway when the waiting time for the specific gateway (e.g., any one of the plurality of replication gateways for the API) exceeds the predetermined threshold time (S873).

Through the configurations as described above, the gateway device 60 according to the present invention can perform the routing on at least one API selected from the client terminal to construct the API gateway and provide the constructed API gateway, thereby enabling the efficient use of the API.

In addition, the gateway device 60 according to the present invention may generate the plurality of replication gateways implemented identically and control the tasks to be distributed to the plurality of replication gateways according to the status of the API gateway, thereby stably processing the predetermined task requested by the API gateway from the client terminal.

Furthermore, the present invention described above may be implemented as a program executed by one or more processes in an electronic device and stored in a computer- readable recording medium.

Accordingly, the present invention can be implemented as a computer-readable code or instruction on a medium in which a program is recorded. That is, various control methods according to the present invention may be provided in the form of integrated or individual programs.

Meanwhile, the computer-readable medium may include all kinds of recording devices in which data that may be read by a computer system are stored. Examples of the computer-readable medium include a hard disk drive (HDD), a solid state disk (SSD), a silicon disk drive (SDD), a read only memory (ROM), a random access memory (RAM), a compact disk (CD)-ROM, a magnetic tape, a floppy disk, an optical data storage device, and the like.

Furthermore, the computer-readable medium may include a storage and may be a server or a cloud storage that an electronic device may access through communication. In this case, the computer may download the program according to the present invention from the server or cloud storage through wired or wireless communication.

Furthermore, in the present invention, the computer described above is an electronic device equipped with a processor, that is, a central processing unit (CPU), and the type of electronic device is not particularly limited.

Meanwhile, the above-described detailed description is to be interpreted as being illustrative rather than being restrictive in all aspects. The scope of the present invention is to be determined by reasonable interpretation of the claims, and all modifications within an equivalent range of the present invention fall in the scope of the present invention.

What is claimed is:

1. A solution provision system, comprising:
an administrator terminal that transmits information related to a first application programming interface (API) for a specific service using an administrator account;
a platform server that receives a registration request for a second API for a different service from the specific service from a developer terminal, registers the first API and the second API in an API product list, and provides the API product list to a client terminal using a user interface; and
a gateway device that relays a communication connection between the client terminal and a plurality of API servers related to the first API and the second API,
wherein the platform server provides a subscription list indicating at least one of the first API and the second API for which a subscription is requested to the gateway device, based on the subscription request for at least one of the first API and the second API received from the client terminal, and
wherein an API gateway is configured on the gateway device that integrates at least one API based on a subscription list.

2. The solution provision system of claim 1, wherein the platform server receives a registration request for a developer account granted to the developer terminal through an interface provided by the API platform to a client account, and grants authority corresponding to the developer account to login information for the client terminal according to the registration request.

3. The solution provision system of claim 1, wherein the platform server outputs an icon prepared in advance to select a developer mode and an administrator mode to a user interface provided by the API platform to the administrator account.

4. The solution provision system of claim 3, wherein when the administrator terminal selects the administrator mode through the user interface provided by the API platform, the administrator terminal identifies information related to the first API and the second API uploaded to the platform server through the user interface provided by the API platform to the administrator account, and determines whether to approve the first API and the second API and registers the determined first API and second API in the API product list.

5. The solution provision system of claim 3, wherein when the administrator terminal selects the developer mode through the user interface of the API platform, the administrator terminal uploads information related to the first API to the platform server through the user interface provided by the API platform to a developer account.

6. The solution provision system of claim 1, wherein when two or more functions are selected from among a plurality of functions provided by the at least one API included in the API gateway from the client terminal through the platform server, the gateway device generates an additional route so that the two or more selected functions are called together based on common information from the two or more selected functions.

7. The solution provision system of claim 1, wherein the gateway device identifies an access of the client terminal to the constructed API gateway to generate a log, and transmits the log to the platform server, and
the platform server generates status information and statistical information for the at least one API included in the API gateway based on the log, and provides the status information and the statistical information for the at least one API included in the API gateway through the API platform.

8. The solution provision system of claim 7, wherein the platform server generates an API status report related to the API gateway, the status information and the statistical information based on a user input from the client terminal, and provides the generated API status report to the client terminal.

9. The solution provision system of claim 1, wherein the gateway device includes a plurality of replication gateways that operate identically to the API gateway but have different routes from the API gateway, and
controls the plurality of replication gateways based on a task requested from the client terminal for a plurality of functions provided by the API server.

10. The solution provision system of claim 9, wherein the plurality of replication gateways are generated by transmitting the subscription list received from the platform server to a plurality of sub-gateway devices having different routes.

11. The solution provision system of claim 9, further comprising an API manager device that controls whether to allocate a task to each of the plurality of replication gateways based on a task quantity requested from the client terminal,
wherein the API manager device allocates a task requested for the at least one API to one of the plurality of replication gateways based on a task allocation algorithm prepared in advance.

12. The solution provision system of claim 11, wherein the API manager device compares the task quantity requested per predetermined time unit from the client terminal with a predetermined reference value, and controls whether to allocate the task to each of the plurality of replication gateways based on the comparison result.

13. A solution provision method, comprising:
transmitting, by an administrator terminal, information related to a first API for a specific service using an administrator account;
registering, by a platform server, the first API in an API product list, and when receiving a registration request for a second API for a different service from the specific service from a developer terminal, registering the second API in the API product list, and providing the API product list to a client terminal using a user interface;
providing, by the platform server, a subscription list indicating at least one of the first API and the second API for which a subscription is requested to a gateway device, based on the subscription request for at least one of the first API and the second API received from the client terminal; and
constructing, by the gateway device, an API gateway that integrates the at least one API based on the subscription list, and relaying a communication connection between the client terminal and a plurality of API servers related to the first API and the second API.

14. The solution provision method of claim 13, further comprising receiving a registration request for a developer account granted to the developer terminal through an interface provided by an API platform to a client account, and granting authority corresponding to the developer account to login information for the client terminal according to the registration request.

15. The solution provision method of claim 13, wherein the platform server outputs an icon prepared in advance to select a developer mode and an administrator mode to a user interface provided by the API platform to the administrator account.

16. The solution provision method of claim 13, wherein the gateway device generates a plurality of replication gateways that operate identically to the API gateway but have different routes from the API gateway, and
the plurality of replication gateways are generated by transmitting the subscription list received from the platform server to a plurality of sub-gateway devices having different routes.

17. The solution provision method of claim 16, further comprising controlling, by an API manager device, whether to allocate a task to each of the plurality of replication gateways based on a task quantity requested from the client terminal.

18. A solution provision system, comprising:
a platform server that registers a plurality of APIs in an API product list and provides the API product list to a client terminal using a user interface; and
a gateway device that relays a communication connection between the client terminal and a plurality of API servers related to the plurality of APIs,
wherein the platform server provides a subscription list indicating at least one of the plurality of APIs for which a subscription is requested to the gateway device, based on the subscription request for at least one of the plurality of APIs received from the client terminal,
an API gateway is configured on the gateway device that integrates at least one API based on a subscription list, and
the API gateway includes a plurality of replication gateways that operate identically to the API gateway but have different routes from the API gateway.

19. The solution provision system of claim 18, wherein the gateway device includes:
a storage unit that stores information related to the plurality of APIs; and
a control unit that controls the plurality of replication gateways, and
the control unit controls the plurality of replication gateways based on a task requested from the client terminal for the plurality of functions provided by the API server, identifies status information for each of the plurality of replication gateways, selects any one of the plurality of replication gateways based on the identified result, and processes the task requested from the client terminal using the any one selected replication gateway.
